(19) United States
(12) Patent Application Publication
(10) Pub. No.: US 2026/0259429 A1
(43) Pub. Date: Sep. 3, 2026

(54) LENS ELEMENT

(71) Applicant: ESSILOR INTERNATIONAL, CHARENTON-LE-PONT (FR)

(72) Inventor: Jean-Etienne LEPAGE, CHARENTON-LE-PONT (FR)

(21) Appl. No.: 19/155,789

(22) PCT Filed: Mar. 21, 2024
(86) PCT No.: PCT/EP2024/057654

§ 371 Date: Aug. 12, 2025

(30) Foreign Application Priority Data
Mar. 24, 2023 (EP) 23305403.0

(51) Int. Cl. G02C 7/02

(52) U.S. Cl. CPC G02C 7/022

(57) ABSTRACT

A lens element comprising: —a refractive area configured to provide a refractive power, —a plurality of at least twenty optical elements having a transparent optical function of not focusing an image on the retina of the eye of the wearer when the lens element is worn in standard wearing conditions, wherein at least two reference optical elements from the plurality of optical elements are on either side of a reference point of the lens element and standout from the plurality of optical elements.

### TECHNICAL FIELD

The disclosure relates to a lens element comprising a refractive area configured to provide a refractive power, a plurality of at least twenty optical elements having a transparent optical function of not focusing an image on the retina of the eye of the wearer when the lens element is worn in standard wearing conditions.

The disclosure further relates to a method of determining the position of a lens element according to disclosure and to a system for determining the blocking position of a lens element according to the disclosure.

### BACKGROUND OF THE DISCLOSURE

Myopia of an eye is characterized by the fact that the eye focuses distant objects in front of its retina. Myopia is usually corrected using a concave lens and hyperopia is usually corrected using a convex lens.

Myopia, also referred as to short-sightedness, has become a major public health problem worldwide. Accordingly, a large effort has been made to develop solutions aiming to slow down myopia progression.

Most of the recent management strategies for myopia progression involved acting on the peripheral vision using optical defocus. This approach has received a great deal of interest since works in chicks and primates showed that foveal refractive error could be manipulated through peripheral optical defocus without the involvement of an intact fovea. Several methods and products are used to slow down myopia progression by inducing such peripheral optical defocus. Among these solutions, orthokeratology contact lenses, soft bifocal and progressive contact lenses, circular progressive ophthalmic lenses, and lenses with array of lenslets have been shown to be more or less effective, through randomized controlled trials.

Myopia control solutions with array of lenslets have been proposed, in particular by the applicant. The purpose of this array of lenslets is to provide an optical blurred image, in front of the retina, triggering a stop signal to the eyes growth, while enabling a good vision.

As for conventional lens elements, the lens elements provided with array of lenslets have to be oriented, centered and positioned prior to machining or edging. The present of an array of lenslets can make it tedious to position and/or orient correctly the lens element.

Therefore, there is a need to provide lens elements comprising a plurality of optical elements having a transparent optical function of not focusing an image on the retina of the wearer that can easily and accurately be oriented and/or positioned for example in view of machining a surface of such lens element or edging such lens element.

### SUMMARY OF THE DISCLOSURE

To this end, the disclosure proposes a lens element comprising:
a refractive area configured to provide a refractive power,
a plurality of at least twenty optical elements having a transparent optical function of not focusing an image on the retina of the eye of the wearer when the lens element is worn in standard wearing conditions,
   wherein at least two reference optical elements from the plurality of optical elements are on either side of a reference point of the lens element, for example the fitting cross or prism reference point of the lens element, and standout from the plurality of optical elements.

The disclosure also proposes a lens element comprising:
a refractive area configured to provide a refractive power,
a plurality of at least twenty optical elements having a transparent optical function of not focusing an image on the retina of the eye of the wearer when the lens element is worn in standard wearing conditions,
   wherein at least two reference optical elements from the plurality of optical elements are on either side of a reference point of the lens element at substantially the same radial distance from the reference point and standout from the other optical elements of the plurality of optical elements that are positioned at substantially the same radial distance from the reference point.

Advantageously, having at least two optical elements from the plurality of optical elements on either side of a reference point of the lens element that standout from the plurality of optical elements allows orienting the lens element, for example prior to its blocking in view of being manufactured.

An advantage of the disclosed lens element is that the orientation of the lens element is encoded inside the plurality of optical elements and does not require additional marking such as micro-engravings to determine the orientation of the lens element.

According to further embodiments which can be considered alone or in combination:
at least two reference optical elements are substantially equidistant to the reference point of the lens element; and/or
the at least two reference optical elements standout from the plurality of optical elements at least by their size; and/or
the at least two reference optical elements standout from the plurality of optical elements at least by their refractive index; and/or
the at least two reference optical elements standout from the plurality of optical elements at least by their optical function, for example at least by their mean optical power; and/or
the at least two reference optical elements standout from the plurality of optical elements at least by their shape; and/or
the reference optical elements have a larger diameter, for example at least 10%, greater than the diameters of the other optical elements or the reference optical elements may have a smaller diameter, for example at least 10%, than the diameters of the other optical elements; and/or
the at least two reference optical elements standout from the plurality of optical elements at least by their spectral transmission; and/or
the lens element comprises at least two reference optical elements standout from the plurality of optical elements and each of them standout from the other; and/or
the lens element comprises at least three reference optical elements that standout from the plurality of optical elements, at least two of the refence optical elements are on either side of the reference point and at least one of the reference optical elements provides an orientation reference of the lens element, for example positioned on the outer part of the lens element; and/or
the lens element comprises three reference optical elements that standout from the plurality of optical elements, two of the refence optical elements are on either side of the reference point and one of the reference optical elements provides an orientation reference of the lens element; and/or
the at least two reference optical elements that are aligned with the reference point standout from the other reference elements; and/or
the lens element comprises at least four reference optical elements that standout from the plurality of optical elements, at least two of the refence optical elements are on either side of the reference point and at least two reference optical elements are not aligned with the reference point so as to provide an orientation reference of the lens element, for example positioned on the outer part of the lens element; and/or
the lens element comprises two reference optical elements standout from the plurality of optical elements substantially equidistant to the reference point, the distance between the center of the two reference optical elements is greater than or equal to 33 mm and smaller than or equal to 35 mm, for example substantially equal to 34 mm; and/or
at least 50%, for example at least 80%, for example all, the optical elements have an optical function of focusing an image other than on the retina of the eye of the person when the lens element is worn in standard wearing conditions; and/or
at least 50%, for example at least 80%, for example all, of the optical elements are located on one of the surfaces of the lens element or between the front and the back surfaces of the lens element; and/or
at least 50%, for example at least 80%, for example all, of the optical elements are refractive lenslets; and/or
at least 50%, for example at least 80%, for example all, of the optical elements are positioned on a structured network; and/or
at least one of the reference optical elements stands out from the plurality of optical elements at least in that its position is outside of the structured network; and/or
at least 50%, for example at least 80%, for example all, of the optical elements are positioned the optical elements are positioned along a plurality of concentric rings, for example along at least five concentric rings; and/or
the structured network is a squared mesh or a honeycomb mesh or a triangle mesh or an octagonal mesh; and/or
the ratio of the total area of the optical elements with respect to the total area of the surface of the lens element is greater than or equal 20%, for example greater than or equal to 30%, for example greater than or equal to 40% and smaller than or equal to 80%, for example smaller than or equal to 70%, for example smaller than or equal to 60%; and/or
at least part of one of the front or back surface of the lens element comprises at least one layer of at least one coating element covering at least part of the surfaces on which the optical elements are placed; and/or
at least 50%, for example at least 80%, for example all, of the optical elements are multifocal lenslets; and/or
at least 50%, for example at least 80%, for example all, of the optical elements are diffractive lenslets; and/or
at least 50%, for example at least 80%, for example all, of the optical elements are diffusive lenslets; and/or
at least 50%, for example at least 80%, for example all of the optical elements have an optical function of focusing an image other than on the retina of the eye of the person when the lens element is worn in standard wearing conditions; and/or
at least 50%, for example at least 80%, for example all of the optical elements have an absolute value of cylinder power greater than or equal to 0.1 D, for example greater than or equal to 0.2 D; and/or
the standard deviation of the orientations of the cylinder axis of the at least 50%, for example at least 90%, for example all, of the optical elements is smaller than or equal to 20° with respect to a common predefined direction, for example smaller than or equal to 15° with respect to a common predefined direction; and/or
at least 20%, for example at least 40% of the optical elements have a difference of orientation of the cylinder axis with respect to a common predefined direction smaller than or equal to 5°, for example smaller than or equal to 2°; and/or
the refractive area is formed as the area other than the areas formed as the plurality of optical elements; and/or
the area of each optical elements is greater than or equal to 0.4 mm², for example greater than or equal to 1 mm², and smaller than or equal to 5 mm², for example smaller than or equal to 4.5 mm², for example smaller than or equal to 4 mm²; and/or
for every circular zone having a radius comprised between 2 and 4 mm comprising a geometrical center located at a distance of the framing reference that faces the pupil of the user gazing straight ahead in standard wearing conditions greater than said radius+5 mm, the ratio between the sum of areas of the parts of optical elements located inside said circular zone and the area of said circular zone is greater than or equal to 20%, for example greater than or equal to 30%, for example greater than or equal to 40% and smaller than or equal to 70%, for example smaller than or equal to 60%, for example smaller than or equal to 50%; and/or
for every circular zone having a radius comprised between 2 and 4 mm comprising a geometrical center located at a distance of the framing reference that faces the pupil of the user gazing straight ahead in standard wearing conditions equal to said radius+5 mm, the ratio between the sum of areas of the parts of optical elements located inside said circular zone and the area of said circular zone is greater than or equal to 20%, for example greater than or equal to 30%, for example greater than or equal to 40% and smaller than or equal to 70%, for example smaller than or equal to 60%, for example smaller than or equal to 50%; and/or
at least part of, for example all the concentric rings of optical elements are centered on the optical center of the surface of the lens element on which said optical elements are disposed; and/or
the concentric rings of optical elements have a diameter comprised between 9.0 mm and 60 mm; and/or
the distance between two successive concentric rings of optical elements is greater than or equal to 0.5 mm, for example greater than or equal to 1 mm, the distance between two successive concentric rings being defined by the difference between the outer diameter of a first concentric ring and the inner diameter of a second concentric ring, the second concentric ring being closer to the periphery of the lens element; and/or
the optical element further comprises optical elements positioned radially between two concentric rings; and/or
the mesh structure is a random mesh, for example a Voronoid mesh; and/or
at least part, for example all, of the optical elements have a constant optical power and a discontinuous first derivative between two contiguous optical elements; and/or
at least part, for example all, of the optical elements have a varying optical power and a continuous first derivative between two contiguous optical elements; and/or
the optical elements are configured so that along at least one, section of the lens element, for example a section passing by the optical center of the lens element, the mean sphere of optical elements increases from a point of said section, for example the optical center, towards the peripheral part of said section; and/or
the optical elements are configured so that along at least one section of the lens the cylinder power of optical elements increases from a point of said section, for example the optical center, towards the peripheral part of said section; and/or
the optical elements are configured so that along the at least one section of the lens the mean sphere and/or the cylinder of optical elements increases from the center of said section towards the peripheral part of said section; and/or
the refraction area comprises an optical center and the optical elements are configured so that along at least one, for example at least 50%, for example any, section passing through the optical center of the lens the mean sphere and/or the cylinder power of the optical elements increases from the optical center towards the peripheral part of the lens; and/or
the refraction area comprises a far vision reference point, a near vision reference, and a meridian joining the far and near vision reference points, the optical elements are configured so that in standard wearing conditions along any horizontal section of the lens the mean sphere and/or the cylinder of the optical elements increases from the intersection of said horizontal section with the meridian towards the peripheral part of the lens; and/or
the mean sphere and/or the cylinder power increasing functions along the sections are different depending on the position of said section along the meridian; and/or
the mean sphere and/or the cylinder power increasing functions along the sections are unsymmetrical; and/or
the optical elements are configured so that in standard wearing conditions the at least one section is a horizontal section; and/or
the mean sphere and/or the cylinder power of optical elements increases from a first point of said section towards the peripheral part of said section and decreases from a second point of said section towards the peripheral part of said section, the second point being closer to the peripheral part of said section than the first point; and/or
the mean sphere and/or the cylinder power increasing function along the at least one section is a Gaussian function; and/or
the mean sphere and/or the cylinder power increasing function along the at least one section is a Quadratic function; and/or
the optical elements are configured so that the mean focus of the light rays passing through each optical element is at a same distance to the retina;
and/or
at least one, for example all, of the optical elements is a toric refractive lenslet.

### BRIEF DESCRIPTION OF THE DRAWINGS

Non-limiting embodiments of the disclosure will now be described with reference to the accompanying drawing wherein:

FIG. 1 illustrates a front view of a lens element according to first embodiment of the disclosure;

FIG. 2 illustrates a profile view a lens element according to an embodiment of the disclosure;

FIG. 3 illustrates a front view of a lens element according to a second embodiment of the disclosure;

FIG. 4 illustrates a front view of a lens element according to a third embodiment of the disclosure;

FIG. 5 illustrates the astigmatism axis γ of a lens in the TABO convention; and

FIG. 6 illustrates the cylinder axis γAX in a convention used to characterize an aspherical surface.

Elements in the figures are illustrated for simplicity and clarity and have not necessarily been drawn to scale. For example, the dimensions of some of the elements in the figure may be exaggerated relative to other elements to help to improve the understanding of the embodiments of the present disclosure.

### DETAILED DESCRIPTION OF EMBODIMENTS OF THE DISCLOSURE

The disclosure relates to a lens element intended to be worn by a wearer.

In the reminder of the description, terms like «up», «bottom», «horizontal», «vertical», «above», «below», «front», «rear″ or other words indicating relative position may be used. These terms are to be understood in the wearing conditions of the lens element.

In the context of the present disclosure, the term “lens element” can refer to a semi-finished lens element or an uncut lens element or a spectacle lens element edged to fit a specific spectacle frame or an ophthalmic lens and an optical device adapted to be positioned on the ophthalmic lens. The “lens element” in the context of the present disclosure may have a coating such as a hardcoat, an antireflective stack, a tinted layer or a polarized layer . . . Etc.

As represented in FIGS. 1 to 3, the lens element 10 according to the disclosure comprises a refraction area 12 and a plurality of at least twenty optical elements 14.

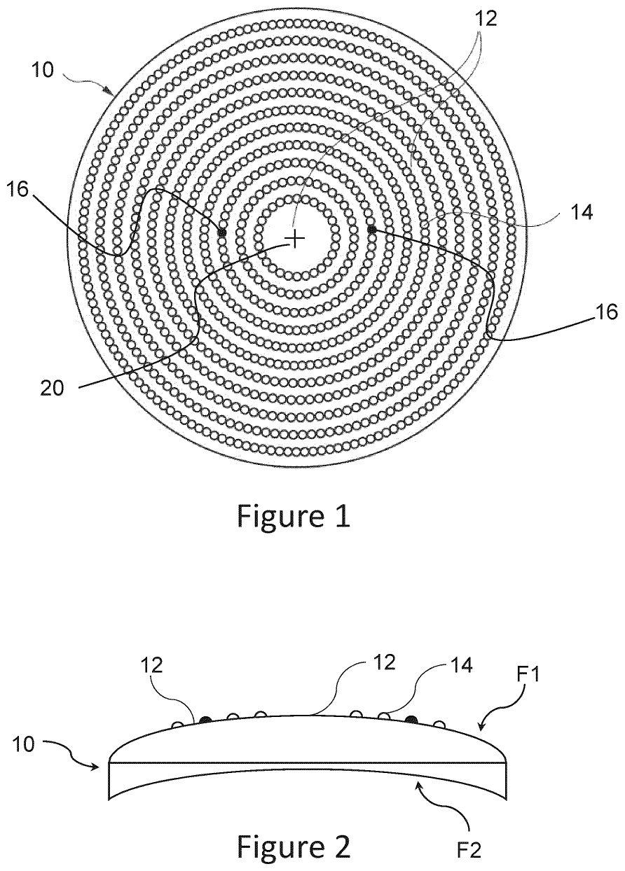

As represented in FIG. 2, the lens element comprises at least a first surface and a second surface opposed to the second surface. For example, the first surface may comprise an object side surface F1 formed as a convex curved surface toward an object side and the second surface may comprise an eye side surface F2 formed as a concave surface having a different curvature than the curvature of the object side surface. The lens element 10 may be made of organic material, thermoset or thermoplastic material, for example polycarbonate, or made of mineral material such as glass.

As illustrated in FIGS. 1 to 3, the lens element 10 comprises a refraction area 12.

When the lens element is a semi-finished lens element, the refraction area 12 is configured to be machined so as to provide a refractive power Px based on the prescription of the eye of the wearer, for example of the person for which the lens element is adapted. The prescription is for example adapted for correcting an abnormal refraction of the eye of the wearer of the lens element.

When the lens element is a finished lens element and has to be edged to fit a specific spectacle, the refraction area 12 has a refractive power Px based on the prescription of the eye of the wearer, for example of the person for which the lens element is adapted. The prescription is for example adapted for correcting an abnormal refraction of the eye of the wearer of the lens element.

The term “prescription” is to be understood to mean a set of optical characteristics of optical power, of astigmatism, of prismatic deviation, determined by an ophthalmologist or optometrist in order to correct the vision defects of the eye, for example by means of a lens positioned in front of his eye. For example, the prescription for a myopic eye comprises the values of optical power and/or of astigmatism with an axis for the distance vision.

The prescription may comprise an indication that the eye of the wearer has no defect and that no refractive power is to be provided to the wearer. In such case the refractive area is configured so as to not provide any refractive power.

The refraction area is preferably formed as the area other than the areas formed of the plurality of optical elements at least in a zone of optical interest centered on the geometrical center of the lens element and having a diameter greater than or equal to 30 mm, for example greater than or equal to 40 mm, and smaller than or equal to 60 mm for example smaller than or equal to 50 mm. In other words, the refraction area is preferably the complementary area to the areas formed of the plurality of optical elements over the zone of optical interest.

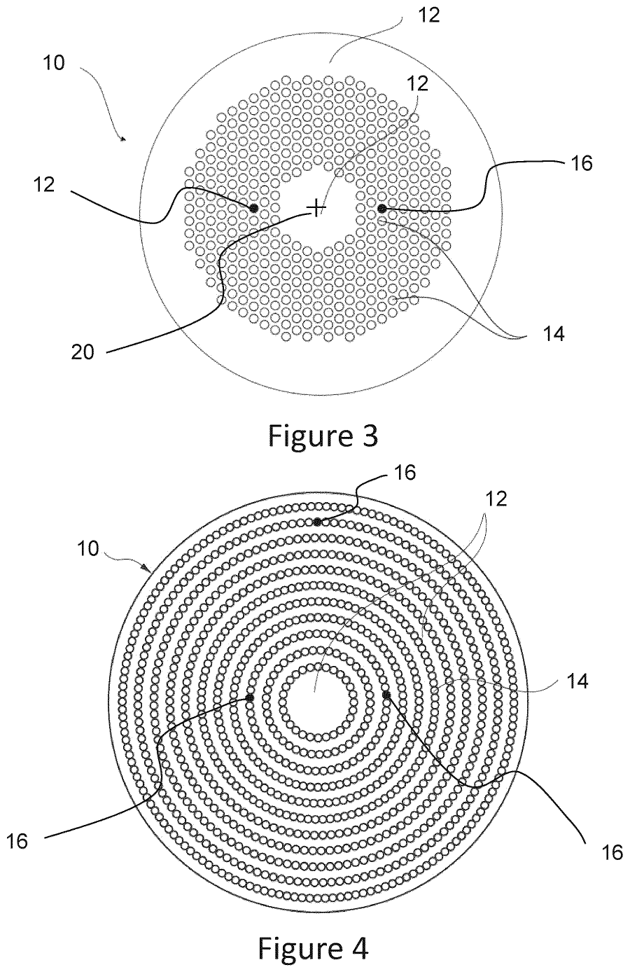

As illustrated in FIGS. 1 and 3, the refraction area 12 may comprise at least the central zone of the lens element 10.

The central zone may have a characteristic dimension greater than or equal to 4 mm and smaller than or equal to 22 mm, for example smaller than of equal to 20 mm.

The central zone may be centered on a reference point of the lens element 10. The reference point on which the central zone may be centered is either one of a geometrical center and/or an optical and/or a near vision reference point and/or a far vision reference point and/or the fitting cross and/or the prism reference point of the lens element.

Preferably, the central zone is centered on, or at least comprises a framing reference point that faces the pupil of the wearer gazing straight ahead in standard wearing conditions.

The wearing conditions are to be understood as the position of the lens element with relation to the eye of a wearer, for example defined by a pantoscopic angle, a Cornea to lens distance, a Pupil-cornea distance, a center of rotation of the eye (CRE) to pupil distance, a CRE to lens distance and a wrap angle.

The Cornea to lens distance is the distance along the visual axis of the eye in the primary position (usually taken to be the horizontal) between the cornea and the back surface of the lens; for example equal to 12 mm.

The Pupil-cornea distance is the distance along the visual axis of the eye between its pupil and cornea; usually equal to 2 mm.

The CRE to pupil distance is the distance along the visual axis of the eye between its center of rotation (CRE) and cornea; for example equal to 11.5 mm.

The CRE to lens distance is the distance along the visual axis of the eye in the primary position (usually taken to be the horizontal) between the CRE of the eye and the back surface of the lens, for example equal to 25.5 mm.

The pantoscopic angle is the angle in the vertical plane, at the intersection between the back surface of the lens and the visual axis of the eye in the primary position (usually taken to be the horizontal), between the normal to the back surface of the lens and the visual axis of the eye in the primary position; for example equal to −8°, preferably equal to 0°.

The wrap angle is the angle in the horizontal plane, at the intersection between the back surface of the lens and the visual axis of the eye in the primary position (usually taken to be the horizontal), between the normal to the back surface of the lens and the visual axis of the eye in the primary position for example equal to 0°.

An example of standard wearing condition may be defined by a pantoscopic angle of −8°, a Cornea to lens distance of 12 mm, a Pupil-cornea distance of 2 mm, a CRE to pupil distance of 11.5 mm, a CRE to lens distance of 25.5 mm and a wrap angle of 0°.

Another example of standard wearing condition more adapted for younger wearers may be defined by a pantoscopic angle of 0°, a Cornea to lens distance of 12 mm, a Pupil-cornea distance of 2 mm, a CRE to pupil distance of 11.5 mm, a CRE to lens distance of 25.5 mm and a wrap angle of 0°.

The central zone may comprise the optical center of the lens element and have a characteristic dimension greater than 4 mm—corresponding to +/−8° peripheral angle on the retina side, and smaller than 22 mm corresponding to +/−440 peripheral angle on the retina side, for example smaller than 20 mm corresponding to +/−400 peripheral angle on the retina side. The characteristic dimension may be a diameter or the major or minor axes of an ellipse shaped central zone.

The refraction area 12 may further comprise at least a second refractive power Pp different from the prescribed refractive power Px. In the sense of the disclosure, the two refractive powers are considered different when the difference between said refractive powers is greater than or equal to 0.25 D, for example greater than 0.5 D.

When the refractive power Px is prescribed to compensate a myopia of the eye of the wearer, the second refractive power Pp may be greater than the refractive power Px.

When the refractive power Px is prescribed to compensate hyperopia of the eye of the wearer, the second refractive power Pp may be smaller than the refractive power Px.

The refraction area 12 may comprise a continuous variation of refractive power. For example, the refractive area may have a progressive addition design. The optical design of the refraction area may comprise a fitting cross where the optical power is negative, and a first zone extending in the temporal side of the refractive are when the lens element is being worn by a wearer. In the first zone, the optical power increases when moving towards the temporal side, and over the nasal side of the lens, the optical power of the ophthalmic lens is substantially the same as at the fitting cross. Such optical design is disclosed in greater details in WO2016/107919.

Alternatively, the refractive power in the refraction area 12 may comprise at least one discontinuity.

As illustrated in FIGS. 1 to 3, the lens element 10 comprises a plurality of at least twenty optical elements 14.

Each optical element 14 has a transparent optical function of not focusing an image on the retina of the eye of the wearer when the lens element is worn in standard wearing conditions, for example when considering an Atchison eye model.

In other words, when the wearer wears the lens element, for example in standard wearing conditions, rays of light passing through the plurality of optical elements will not focus on the retina of the eye of the wearer, for example based on an Atchison eye model. For example, the optical elements may focus in front and/or behind the retina of the eye of the wearer, for example according to an Atchison eye model.

Advantageously, not focusing an image on the retina of the wearer allows creating a control signal that suppresses, reduces, or at least slows down the progression of abnormal refractions, such as myopia or hyperopia, of the eye of the person wearing the lens element.

For example, the optical elements may have an aspherical optical function, that is of not focusing light, creating a volume of light rather than a focus point.

Advantageously, having a volume of light allows creating a control signal that suppresses, reduces, or at least slows down the progression of abnormal refractions, such as myopia or hyperopia, of the eye of the person wearing the lens element with an increase efficiency.

In the sense of the disclosure, an optical element is considered to have a transparent optical function when said optical element absorbs less than 50%, for example less than 80%, for example less than 90% of the light over the visible spectrum, i.e. 380 nm to 750 nm.

As illustrated on FIGS. 1 to 3, at least two reference optical elements 16 from the plurality of optical elements are on either side of a reference point 20 and standout from the plurality of optical elements 14.

According to an embodiment of the disclosure, the at least two reference optical elements from the plurality of optical elements are on either side of a reference point of the lens element at substantially the same radial distance from the reference point and standout from the other optical elements of the plurality of optical elements that are positioned at substantially the same radial distance from the reference point.

In the sense of the disclosure, two reference optical elements are considered substantially the same radial distance from the reference point when the difference of radial distance is smaller than or equal to the average radius of the optical elements, for example smaller than or equal to half of the average radius of the optical elements, for example smaller than or equal to 20% of the average radius of the optical elements.

The average radius may be determined using any known measuring method, for example a fringe deflectometry method such as disclosed in WO2021069443. The reference point may be either one of a geometrical center and/or an optical center and/or a near vision reference point and/or a far vision reference point and/or the fitting cross and/or the prism reference point of the lens element.

The fitting cross is the point on the lens element where the wearer's eye should be looking through for optimal visual acuity and clarity. It is located at the intersection of the horizontal and vertical axes of the lens element.

To determine the position of the fitting cross, various measurements are taken, including the wearer's pupillary distance (PD) and other facial features. These measurements are used to align the lens with the wearer's eye, so that the fitting cross is positioned correctly in front of the eye.

Once the fitting cross has been identified, the lens can be properly mounted into the frame so that it aligns with the wearer's eyes. Proper alignment of the lens element with the fitting cross is important for ensuring that the wearer's vision is clear and accurate.

The fitting cross is a crucial aspect of ophthalmic lens fitting that ensures optimal visual acuity and clarity for the wearer. It is used to properly position the lens element within a spectacle frame so that it aligns with the patient's visual axis.

The prism reference point (PRP) is a point on a lens where any prism correction is centered. Prism correction is used to correct binocular vision problems where the eyes are not properly aligned, which can cause double vision or eye strain.

The PRP is determined by taking into account the wearer's prescription, the lens power, and the position of the wearer's eyes in relation to the lens. The PRP is typically located on the lens's vertical axis, and it is important to ensure that it is properly aligned with the wearer's eyes.

At least 50%, for example at least 80%, for example all, of a surface of the optical element 10 may be covered by at least one layer of coating element. The at least one layer of coating element may comprise features selected from the group consisting of anti-scratch, anti-reflection, anti-smudge, anti-dust, UV30 filtration, blue light-filtration, anti-abrasion features.

The layer of coating element may be provided using any known techniques. For example, the layer of coating may be provided using a dipping process where the lens element simultaneously receives a layer of coating on each surface.

Preferably as illustrated on FIGS. 1 to 3, the two reference optical elements are substantially equidistant to the reference point. Advantageously, such configuration makes it easier to identify either the reference optical elements knowing the position of the refence point or finding the reference point knowing the position of the two reference optical elements.

The reference optical elements may stand out from the other optical elements by their size.

For example, the reference optical elements may have a larger diameter, for example at least 10%, for example at least 20% greater than the diameters of the other optical elements, for example about 50% greater or even twice as big.

For example, the reference optical elements may have a smaller diameter, for example at least 10%, for example at least 20% smaller than the diameters of the other optical elements, for example about half the size of the other optical elements.

Advantageously, having reference optical element that standout by their size allows identify them very easily without requiring the use of any complex measuring devices.

The reference optical elements may alternatively or in addition standout from the plurality of optical elements at least by their refractive index. Typically, the reference optical elements may have a different refractive index than the other optical elements and then the material of the lens element. For example the refractive index of the reference optical element may be greater or smaller than the refractive index of the other optical elements by at least 0.01, for example greater or smaller by 0.05, more likely greater or smaller by a value of difference of index comprised between 0.01 and 0.5, more likely between 0.01 and 0.2, more likely between 0.02 and 0.1.

Advantageously, standing out by a different optical index may provide a more esthetic result for the ophthalmic lens, increasing acceptability of the wearer, in particular for children.

The reference optical elements may alternatively or in addition standout from the plurality of optical elements at least by their optical function, for example by their mean optical power. Typically, the reference optical elements may have a different optical function than the other optical elements. For example, the mean optical power of the reference optical element may be 10% greater or smaller than the mean optical power of the other optical elements, for example 20% greater or smaller. Such change in optical function may be by have those reference optical elements have a different index and/or a different curvature or different pi-fresnel structure than the other optical elements.

Advantageously, having reference optical element standing out by a different optical function provides an esthetic result for the ophthalmic lens, increasing acceptability of the wearer, in particular for children and the reference optical element can be identified using simple optical measuring devices.

The reference optical elements may alternatively or in addition standout from the plurality of optical elements at least by their shape, for example by the outline of the optical element or the curvature of the optical element. Typically, the reference optical elements may have a different outline than the other optical elements and/or a different curvature than the other optical elements.

Advantageously, having reference optical element standing out by a different shape allows to identify them very easily without requiring the use of any complex measuring devices. It is further easy for automated devices to identify the reference optical elements as being different without needing complex treatment or analysis software.

The reference optical elements may alternatively or in addition standout from the plurality of optical elements at least by their spectral transmission, for example by determining the spectral transmission at a specific wavelength or over a specific range of wavelengths such as between 400 nm and 700 nm. Typically, the reference optical elements may have a different spectral transmission than the other optical elements and/or than the refractive area.

Advantageously, having reference optical element standing out by a different spectral transmission allows to identify them very easily and quickly without requiring the use of any complex measuring devices. It is further easy for automated devices to identify the reference optical elements as being different without needing complex treatment or analysis software.

According to an embodiment, the reference optical element may correspond to the absence of optical element, in particular when the plurality of optical elements are positioned on a structured network.

According to an embodiment, in addition to standing out from the plurality of optical elements, each reference optical elements may stand out one from the other. Advantageously, such configuration allows determining an orientation of the lens element of for example identifying a lens element to be positioned before the right or left eye of the wearer.

Each reference optical element may standout from the other either by it size and/or its refractive index and/or its optical function, such as mean optical power, and/or its shape.

According to an embodiment, the optical element comprises two reference optical elements that standout from the plurality of optical elements substantially equidistant to the reference point, the distance between the centers of each of the two reference optical elements is greater than or equal to 33 mm and smaller than or equal to 35 mm, for example substantially equal to 34 mm.

Advantageously, such distance corresponds to the commonly used distance between the technical markings known as micro-engraving in most lens elements. Such micro-engraving being commonly used to help determine the optical center on progressive addition lenses notably.

As illustrated on FIG. 4, the lens element according to the disclosure may comprise at least three reference optical elements 16 that standout from the plurality of optical elements, at least two of the refence optical elements are on either side of the reference point and at least one of the reference optical elements provides an orientation reference of the lens element, for example being positioned on the outer part of the lens element. Advantageously the third element is in an outer part of the lens element that is determined to be edged or most likely edged during the edging step used to conform the optical element into a contour adapted to be fitted in the predetermined frame.

Advantageously, the third reference optical element may be used to determine the orientation of the lens element. For example, the third reference lens element may be used to determine the top of the lens element, or the bottom and/or nasal or temporal direction or an axis of particular importance.

According to an embodiment of the disclosure, the lens element comprises three reference optical elements that standout from the plurality of optical elements, two of the refence optical elements are on either side of the reference point and one of the reference optical elements provides an orientation reference of the lens element.

Advantageously, having three reference optical elements allows positioning and orienting the lens element with a minimum reference optical element. Therefore, making the identification easier and quicker.

Alternatively, the lens element may comprise at least four reference optical elements that standout from the plurality of optical elements, ate least two of the refence optical elements are on either side of the reference point and at least two reference optical elements are not aligned with the reference point so as to provide an orientation reference of the lens element, for example positioned on the outer part of the lens element.

Advantageously, having at least four reference optical elements allows ensure redundancy of the position and orientation information. Therefore, making the positioning and orientation more accurate.

According to an embodiment, at least 50%, preferably more than 80%, more preferably all the optical elements 14 may be configured, for example in standard wearing conditions, to focus elsewhere than on the retina of the wearer. In other words, the plurality of optical elements may be configured to focus in front and/or behind the retina of the eye of the wearer.

At least 50%, preferably more than 80%, for example all, of the optical elements 14 has a shape configured so as to create a caustic in front of the retina of the eye of the person. In other words, such optical element is configured so that, when the person wears the lens element in standard viewing condition, every section plane where the light flux is concentrated due to some of the optical elements 14, if any, is located in front of the retina of the eye of the person.

In an embodiment, at least one optical element 14 within the zone of interest 20 bears a cylindrical component on its surface.

Advantageously, having a controlled cylinder orientation of each of the optical elements improves the quality of the vision and the quality of the myopia or hyperopia slow down function of the lens element.

At least 50%, for example at least 80%, for example all of the optical elements comprised in the zone of interest have an absolute value of cylinder power greater than or equal to 0.1 D, for example greater than or equal to 0.2 D.

According to an embodiment of the disclosure, at least 50%, for example at least 80%, for example all, of the optical elements are refractive lenslets, for example aspherical lenslets and at least 50%, for example at least 80%, for example all of the optical elements of the lens element have an absolute value of cylinder power greater than or equal to 0.1 D, for example greater than or equal to 0.2 D.

As is known, a minimum curvature CURVₘᵢₙ may be defined at any point on an aspherical surface by the formula:

$${CURV}_{min} = \frac{1}{{R}_{max}} ,$$

where Rₘₐₓ is the local maximum radius of curvature, expressed in meters and CURVₘᵢₙ is expressed in diopters.

Similarly, a maximum curvature CURVₘₐₓ can be defined at any point on an aspheric surface by the formula:

$${CURV}_{max} = \frac{1}{{R}_{min}} ,$$

where Rₘᵢₙ is the local minimum radius of curvature, expressed in meters and CURVₘₐₓ is expressed in diopters.

It can be noticed that when the surface is locally spherical, the local minimum radius of curvature Rmin and the local maximum radius of curvature Rmax are the same and, accordingly, the minimum and maximum curvatures CURVmin and CURVmax are also identical. When the surface is aspherical, the local minimum radius of curvature Rmin and the local maximum radius of curvature Rmax are different.

From these expressions of the minimum and maximum curvatures CURVmin and CURVmax, the minimum and maximum spheres labeled SPHmin and SPHmax can be deduced according to the kind of surface considered.

When the surface considered is the object side surface (also referred to as the front surface), the expressions are the following:

$${SPH}_{min} = ( n - 1 ) * {CURV}_{min} = \frac{n - 1}{{R}_{max}} and {SPH}_{max} = ( n - 1 ) * {CURV}_{max} = \frac{n - 1}{{R}_{min}}$$

where n is the refraction index of the constituent material of the lens.

If the surface considered is an eyeball side surface (also referred to as the back surface), the expressions are the following:

$${SPH}_{min} = ( 1 - n ) * {CURV}_{min} = \frac{1 - n}{{R}_{max}} and {SPH}_{max} = ( 1 - n ) * {CURV}_{max} = \frac{1 - n}{{R}_{min}}$$

where n is the refraction index of the constituent material of the lens.

As is well known, a mean sphere SPHₘₑₐₙ at any point on an aspherical surface can also be defined by the formula:

$${SPH}_{mean} = \frac{1}{2} ( {SPH}_{min} + {SPH}_{max} )$$

The expression of the mean sphere therefore depends on the surface considered:
if the surface is the object side surface,

$${SPH}_{mean} = \frac{n - 1}{2} ( \frac{1}{{R}_{min}} + \frac{1}{{R}_{max}} )$$

if the surface is an eyeball side surface,

$${SPH}_{mean} = \frac{1 - n}{2} ( \frac{1}{{R}_{min}} + \frac{1}{{R}_{max}} )$$

A cylinder CYL is also defined by the formula CYL=|SPHₘₐₓ−SPHₘᵢₙ|.

The characteristics of any aspherical face of the lens may be expressed by the local mean spheres and cylinders.

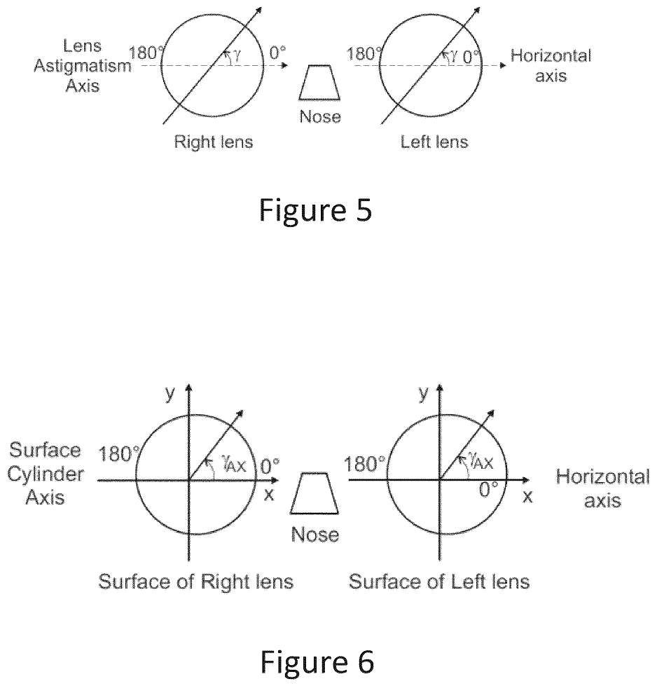

For an aspherical surface, a local cylinder axis γ_{AX} may further be defined. FIG. 5 illustrates the astigmatism axis γ as defined in the TABO convention and FIG. 6 illustrates the cylinder axis γ_{AX} in a convention defined to characterize an aspherical surface.

The cylinder axis γ_{AX} is the angle of the orientation of the maximum curvature CURVₘₐₓ with relation to a reference axis and in the chosen sense of rotation. In the above defined convention, the reference axis is horizontal (the angle of this reference axis is 0°) and the sense of rotation is counterclockwise for each eye, when looking at the wearer (0°≤γ_{AX}≤180°). An axis value for the cylinder axis γ_{AX} of +45° therefore represents an axis oriented obliquely, which when looking at the wearer, extends from the quadrant located up on the right to the quadrant located down on the left.

At least part, for example more than 50%, preferably all, of the optical elements 14 may be lenslets having a contour shape being inscribable in a circle having a diameter greater than or equal to 0.2 mm, for example greater than or equal to 0.4 mm, for example greater than or equal to 0.6 mm, for example greater than or equal to 0.8 mm and smaller than or equal to 2.0 mm, for example smaller than or equal to 1.0 mm.

For example, the area of each optical elements is greater than or equal to 0.4 mm² and smaller than or equal to 5 mm², for example smaller than or equal to 4 mm².

The ratio of the total area of the optical elements with respect to the total area of the surface of the lens element may be greater than or equal 20%, for example greater than or equal to 20%, for example greater than or equal to 30% and smaller than or equal to 80%, for example smaller than or equal to 70%, for example smaller than or equal to 60%.

As illustrated on FIG. 2, at least part, for example all, of the optical elements 14 may be located on the front surface of the lens element. The front surface of the lens element corresponds to the object side F1 of the lens element facing towards the object.

At least part, for example all, of the optical elements 14 may be located on the back surface of the lens element. The back surface of the lens element corresponds to the eye side F2 of the lens element facing towards the eye.

At least part, for example all, of the optical elements 14 may be located between the front and the back surfaces of the lens element, for example when the lens element is encapsulated between two lens substrates. Advantageously, it provides a better protection to the optical elements.

For every circular zone having a radius comprised between 2 and 4 mm comprising a geometrical center located at a distance of the optical center of the lens element greater to said radius+5 mm, the ratio between the sum of areas of the optical elements 14 located inside said circular zone and the area of said circular zone may be greater than or equal to 20%, for example greater than or equal to 30%, for example greater than or equal to 40% and smaller than or equal to 80%, for example smaller than or equal to 70%, for example smaller than or equal to 60%.

For every circular zone having a radius comprised between 2 and 4 mm comprising a geometrical center located at a distance of the optical center of the lens element equal to said radius+5 mm, the ratio between the sum of areas of the optical elements 14 located inside said circular zone and the area of said circular zone may be greater than or equal to 20%, for example greater than or equal to 30%, for example greater than or equal to 40% and smaller than or equal to 80%, for example smaller than or equal to 70%, for example smaller than or equal to 60%.

The optical elements may be randomly distributed on the lens element.

Alternatively and as illustrated in FIGS. 1 and 4, the optical elements 14 may be organized along a plurality of concentric rings. The concentric rings of optical elements may be annular rings.

Advantageously, such configuration provides a great balance between the slowdown of the abnormal refraction of the eye of the wearer and the visual performances or comfort of the wearer.

The lens element may comprise optical elements disposed in at least two concentric rings, preferably more than 5, more preferably more than 10 concentric rings. For example, the optical elements may be disposed in 11 concentric rings centered on the optical center of the lens.

The diameter of all optical elements on a concentric ring of the lens element may be identical apart from the reference optical elements that may standout by their size. For example, all the optical elements on the lens element have an identical diameter apart from the reference optical elements that may standout by their size.

The zone of interest within which the optical elements have a controlled cylinder may extend radially from the optical center of the lens element.

As illustrated on FIG. 1, when the optical elements are positioned along at least 5 concentric rings and the zone of interest extends radially over at least 5 of the concentric rings.

Alternatively, at least 50%, for example at least 80%, for example all of the optical elements are positioned on the lens element on a mesh, for example a structured mesh. The structured mesh may be a squared mesh or a hexagonal mesh or a triangle mesh or an octagonal mesh or a honeycomb mesh. Alternatively, the mesh structure may be a random mesh, for example a Voronoi mesh.

FIG. 3 illustrates an embodiment wherein the optical elements are positioned on a honeycomb mesh.

The disclosure further relates to a method of determining the position of a lens element according to any arrangement disclosed previously.

The method may comprise:
providing a lens element according to the disclosure on a lens element blocker,
detecting the at least two reference optical elements of the lens element, and
determining the relative positions of the lens element and the lens element blocker based on the at least two reference optical elements of the lens element.

The disclosure further relates to a system for determining the blocking position of a lens element according to any arrangement disclosed previously. The device may comprise:
a lens element blocker adapted to receive a lens element,
an optical element detecting device configured to detect the at least two reference optical elements of the lens element on the lens element blocker, and
a processor configured to execute a program that allows determining the relative positions of the lens element and the lens element blocker based on the at least two reference optical elements of the lens element.

The disclosure has been described above with the aid of embodiments without limitation of the general inventive concept. Many further modifications and variations will be apparent to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. A lens element comprising:
a refractive area configured to provide a refractive power,
a plurality of at least twenty optical elements having a transparent optical function of not focusing an image on the retina of the eye of the wearer when the lens element is worn in standard wearing conditions,
wherein
at least two reference optical elements from the plurality of optical elements are on either side of a reference point of the lens element at substantially the same radial distance from the reference point and standout from the other optical elements of the plurality of optical elements that are positioned at substantially the same radial distance from the reference point.

2. The lens element according to claim 1, wherein the at least two reference optical elements are substantially equidistant to the reference point of the lens element.

3. The lens element according to claim 1, wherein the at least two reference optical elements standout from the plurality of optical elements at least by their size.

4. The lens element according to claim 3, wherein the reference optical elements have a larger diameter, greater than the diameters of the other optical elements or the reference optical elements may have a smaller diameter than the diameters of the other optical elements.

5. The lens element according to claim 1, wherein the at least two reference optical elements standout from the plurality of optical elements at least by their shape.

6. The lens element according to claim 1, comprising at least three reference optical elements that standout from the plurality of optical elements, at least two of the refence optical elements are on either side of the reference point and at least one of the reference optical elements provides an orientation reference of the lens element.

7. The lens element according to claim 6, comprising three reference optical elements that standout from the plurality of optical elements, two of the refence optical elements are on either side of the reference point and one of the reference optical elements provides an orientation reference of the lens element.

8. The lens element according to claim 6, wherein the at least two reference optical elements that are align with the reference point standout from the other reference elements.

9. The lens element according to claim 1, wherein at least 50% of the optical elements are located on one of the surfaces of the lens element or between the front and the back surfaces of the lens element.

10. The lens element according to claim 1, wherein at least 50% of the optical elements are refractive lenslets.

11. The lens element according to claim 1, wherein at least 50%, of the optical elements are positioned on a structured network.

12. The lens element according to claim 10, wherein at least 50% of the optical elements are positioned the optical elements are positioned along a plurality of concentric rings.

13. The lens element according to claim 10, wherein the structured network is a squared mesh or a honeycomb mesh or a triangle mesh or an octagonal mesh.

14. A method of determining the position of a lens element according to any of the preceding claims, the method comprising:
providing a lens element according to claim 1 on a lens element blocker,
detecting the at least two reference optical elements of the lens element, and
determining the relative positions of the lens element and the lens element blocker based on the at least two reference optical elements of the lens element.

15. A system for determining the blocking position of a lens element according to claim 1, the device comprising:
a lens element blocker adapted to receive a lens element,
an optical element detecting device configured to detect the at least two reference optical elements of the lens element on the lens element blocker, and
a processor configured to execute a program that allows determining the relative positions of the lens element and the lens element blocker based on the at least two reference optical elements of the lens element.
